(19) United States
(12) Patent Application Publication
(10) Pub. No.: US 2025/0085478 A1
(43) Pub. Date: Mar. 13, 2025

(54) OPTICAL WAVEGUIDE DEVICE

(71) Applicants: SHINKO ELECTRIC INDUSTRIES CO., LTD., Nagano (JP); KEIO UNIVERSITY, Tokyo (JP)

(72) Inventors: Yuji FURUTA, Nagano (JP); Takaaki Ishigure, Kagagawa (JP); Fumimasa Kondo, Kanagawa (JP)

(21) Appl. No.: 18/824,111

(22) Filed: Sep. 4, 2024

(30) Foreign Application Priority Data
Sep. 8, 2023 (JP) 2023-146474

(51) Int. Cl. G02B 6/26; G02B 6/02

(52) U.S. Cl. CPC G02B 6/262; G02B 6/02033

(57) ABSTRACT

An optical waveguide device includes a substrate, a first waveguide disposed on or in the substrate, and a second waveguide disposed on a first surface of the substrate, wherein the second waveguide includes a core and a cladding covering the core, wherein throughout an entirety of a predetermined region, a portion of the core overlaps the first waveguide when viewed from a direction normal to the first surface, in wherein the predetermined region, the core has a bottom surface in contact with the first surface and a convex surface connected to the bottom surface, and wherein the core includes a portion whose thickness gradually decreases from a widthwise center to widthwise ends in a transverse cross-sectional view.

### CROSS-REFERENCE TO RELATED APPLICATIONS

The present application i based on and claims priority to Japanese Patent Application No. 2023-146474 filed on Sep. 8, 2023, with the Japanese Patent Office, the entire contents of which are incorporated herein by reference.

### FIELD

The disclosures herein relate to optical waveguide devices.

### BACKGROUND

Techniques for optically coupling a silicon waveguide and a polymer waveguide are known in the art. One example is a technique that forms a polymer waveguide so as to cover the silicon waveguide by the Mosquito method and realizes low-loss optical coupling between the silicon waveguide and the polymer waveguide by adiabatic coupling (see Patent Document 1, for example).

As illustrated in FIG. 1 of Patent document 1, in the above-described technique, a core having a cross-sectional is substantially circular shape fabricated and connected to a silicon waveguide on the lower side of the substantially circular core. Since the width of the substantially circular core becomes narrower toward the bottom, a shift of the position of the core in the width direction may cause the optical coupling efficiency with the silicon waveguide to be lowered.

There may be a need to provide an optical waveguide device in which two waveguides are coupled with high optical coupling efficiency.

### PRIOR ART DOCUMENT

### Patent Document

Japanese Laid-open Patent [Patent document 1] Publication No. 2018-97012

### SUMMARY

According to an aspect of the embodiment, an optical waveguide device includes a substrate, a first waveguide disposed on or in the substrate, and a second waveguide disposed on a first surface of the substrate, wherein the second waveguide includes a core and a cladding covering the core, wherein throughout an entirety of a predetermined region, a portion of the core overlaps the first waveguide when viewed from a direction normal to the first surface, wherein in the predetermined region, the core has a bottom surface in contact with the first surface and a convex surface connected to the bottom surface, and wherein the core includes a portion whose thickness gradually decreases from a widthwise center to widthwise ends in a transverse cross-sectional view.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A through 1C are drawings illustrating an example of an optical waveguide device according to a first embodiment;

FIGS. 2A and 2B are drawings illustrating another example of the cross-sectional shape of a core;

FIGS. 3A and 3B are drawings illustrating another example of the cross-sectional shape of the core;

FIGS. 4A through 4D are drawings illustrating an example of the manufacturing process of the optical waveguide device according to the first embodiment;

FIG. 5 is a photographic image illustrating an example of the cross-sectional shape of the core;

FIGS. 6A and 6B are diagrams illustrating the results of simulation;

FIGS. 7A and 7B are drawings illustrating the results of simulation;

FIGS. 8A and 8B are tables illustrating the results of simulation;

FIGS. 9A through 9C are drawings illustrating an example of an optical waveguide device according to a first variation of the first embodiment;

FIG. 10 is a view illustrating one end of the optical waveguide device viewed from the positive X side toward the negative X side; and

FIG. 11 is a cross-sectional view illustrating an example of an optical waveguide device according to a second variation of the first embodiment.

### DESCRIPTION OF EMBODIMENTS

In the following, embodiments of the invention will be described with reference to the accompanying drawings. In these drawings, the same components are referred to by the same reference numerals, and duplicate descriptions thereof may be omitted.

### First Embodiment

### [Optical Waveguide Device]

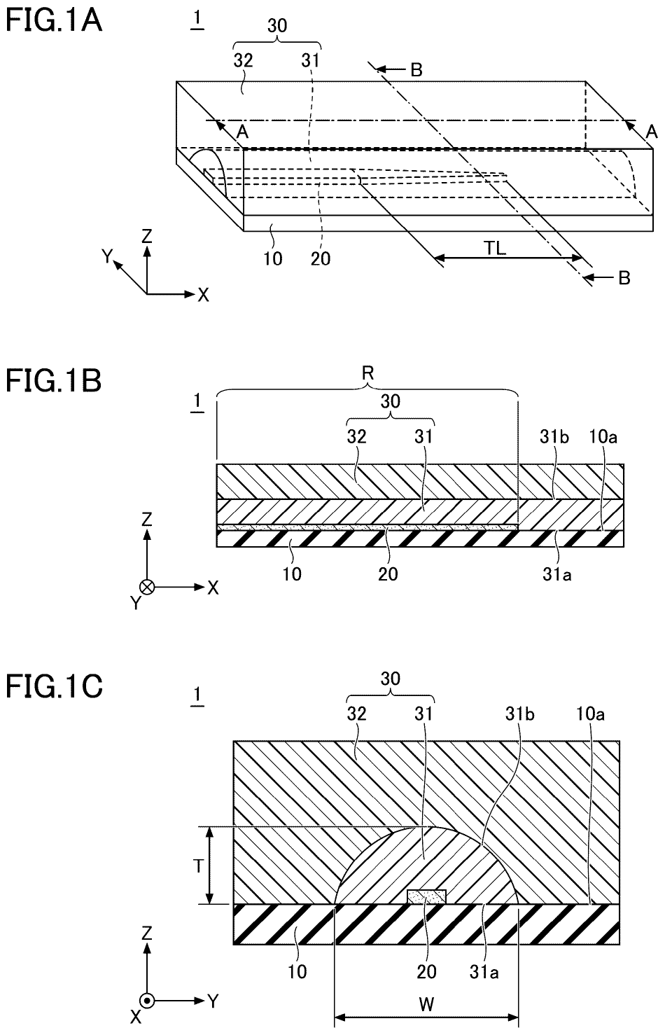

FIGS. 1A through 1C are drawings illustrating an example of an optical waveguide device according to the first embodiment. FIG. 1A is an axonometric view, and FIG. 1B is a cross-sectional view taken along the line A-A in FIG. 1A. FIG. 1C is a cross-sectional view taken along the line B-B in FIG. 1A. To be more specific, FIG. 1B illustrates a cross-sectional view of the optical waveguide device 1 cut in a plane parallel to the XZ plane through the center of a core 31 in the longitudinal direction.

In FIGS. 1A through 1C, as an example, the shape of the optical waveguide device 1 is a rectangular parallelepiped. The direction parallel to one edge of the bottom surface of the rectangular parallelepiped is the X direction, and the direction perpendicular to the X direction on the bottom surface of the rectangular parallelepiped is the Y direction. The direction perpendicular to the X direction and the Y direction (i.e., the thickness direction of the rectangular parallelepiped) are the Z direction (the same applies to the following drawings).

Referring to FIGS. 1A through 1C, the optical waveguide device 1 includes a substrate 10, a first waveguide 20, and a second waveguide 30. The second waveguide 30 includes a core 31 and a cladding 32 surrounding the core 31.

The substrate 10 may be formed of, for example, SiO₂, SiO_{X}, or the like. The substrate 10 may have a structure in which an upper layer made of SiO₂, SiO_{X}, or the like is formed on a lower layer made of Si. In this embodiment, the first waveguide 20 is provided on the first surface 10a of the substrate 10. That is, the lower surface of the first waveguide 20 is in contact with the first surface 10a, and the upper surface and side surfaces of the first waveguide 20 are not covered by the substrate 10. The first waveguide 20 is, for example, a silicon waveguide. Silicon waveguides are fine optical waveguides formed in silicon chips. The first waveguide 20 is not limited to a silicon waveguide, and may be made of silicon nitride, gallium arsenide, lithium niobate, or the like instead of silicon.

The first waveguide 20 is arranged such that, for example, the propagation direction of the signal light is the same as that of the core 31, and the distance (gap) between them in the Z-axis direction is as short (narrow) as possible. (The distance is zero in this embodiment.) The region R represents a region throughout an entirety of which the first waveguide 20 and the core 31 overlap when viewed from the direction (i.e., Z direction) normal to the first surface 10a (hereinafter referred to as plan view). The width of the first waveguide 20 may or may not be constant, but it is preferable that the width gradually decreases toward one side in the X direction. In this embodiment, the first waveguide 20 in the region R includes a portion whose width gradually decreases toward one side in the longitudinal direction (i.e., toward the positive X direction) in plan view. That is, in this embodiment, a portion of the first waveguide 20, which portion is toward the positive X direction, has a tapered shape in plan view. The length TL of the tapered portion in the X direction may be, for example, about 200 μm to 1000 μm. In the region R, the first waveguide 20 preferably includes a portion whose width gradually decreases toward one side in the longitudinal direction (positive X direction) in plan view.

With such a shape, the optical coupling efficiency between the first waveguide 20 and the core 31 can be improved. The width of the first waveguide 20 is, for example, about 200 nm to 500 nm except for the tapered portion. The width of the tip of the tapered portion is, for example, about ½ to ¼ of the constant width portion. The thickness of the first waveguide 20 is constant. The thickness of the first waveguide 20 is, for example, about 20 nm to 300 nm.

The second waveguide 30 is provided on the first surface 10a of the substrate 10. The second waveguide 30 is, for example, a polymer waveguide. The core 31 of the second waveguide 30 is provided on the first surface 10a of the substrate 10. The core 31 and the first waveguide 20 are adiabatically coupled. The core 31 may be formed of a material mainly composed of a silicone resin, for example. The core 31 may alternatively be formed of a material mainly composed of an acrylic resin, an epoxy resin, a polyimide resin, a polyolefin resin, a polynorbornene resin, or the like. Alternatively, the core 31 may be formed of a material obtained by mixing these resins. Alternatively, the core 31 may be formed of an inorganic glass such as quartz or borosilicate.

The core 31 may be an SI type having a uniform refractive index in the plane. In this case, the refractive index of the core 31 may be higher than that of the substrate 10, and may be about 1.5 to 1.6, for example. The core 31 is preferably a GI type having a higher refractive index toward the center and a lower refractive index toward the periphery. In this case, the refractive index of the center portion of the core 31 may be higher than that of the substrate 10, and may be about 1.5 to 1.6, for example.

The core 31 in the region R overlaps (is positioned directly above) the first waveguide 20 in plan view. In the region R, the width of the core 31 (i.e., the dimension in the Y direction in the example illustrated in FIG. 1) is larger than the width of the first waveguide 20 (i.e., the dimension in the Y direction in the example illustrated in FIG. 1) at any position in the longitudinal direction (i.e., the X direction in the example illustrated FIG. 1) of the first waveguide 20 in plan view. The core 31 preferably covers the entire width of the first waveguide 20. In other words, the core 31 preferably covers the upper surface and longitudinal lateral surfaces of the first waveguide 20. In the vicinity of the end portion of the first waveguide 20 on the negative X side, there may be a region where the first waveguide 20 is exposed from the core 31.

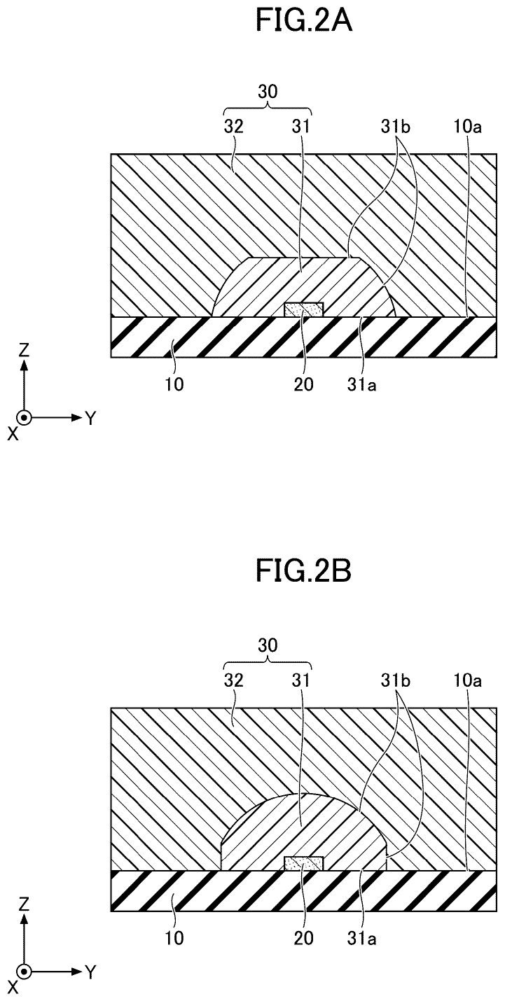

In the region R, the core 31 has a bottom surface 31a in contact with the first surface 10a and a convex surface 31b connected to the bottom surface 31a. In the example illustrated in FIG. 1, the convex surface 31b is constituted by a curved surface. The convex surface 31b may be constituted by a curved surface and a flat surface. For example, as illustrated in FIG. 2A, the top surface of the convex surface 31b may be a flat surface, and both side surfaces connecting the top surface and the bottom surface 31a may be curved surfaces. Further, as illustrated in FIG. 2B, the upper surface of the convex surface 31b may be a convex curved surface, and both side surfaces connecting the upper surface and the bottom surface 31a may be flat surfaces. These side surfaces may or may not be perpendicular to the bottom surface 31a.

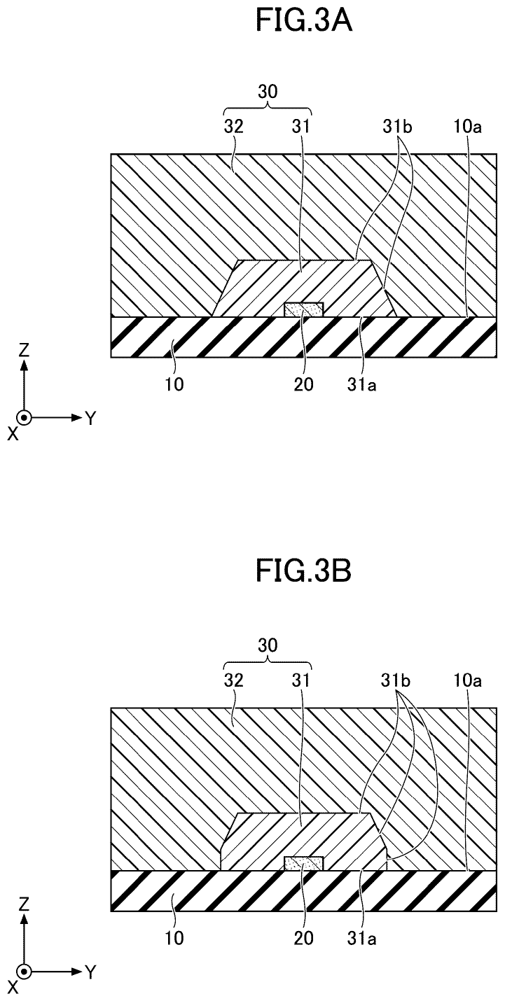

Alternatively, the convex surface 31b may be constituted only by flat surfaces. For example, as illustrated in FIG. 3A, the upper surface of the convex surface 31b may be a flat surface, and both side surfaces connecting the upper surface and the bottom surface 31a may be inclined flat surfaces that slope outwards toward the substrate 10. Further, as illustrated in FIG. 3B, substantially vertical flat surfaces may be formed on the substrate 10 side of the inclined flat surfaces in the shape illustrated in FIG. 3A. Alternatively, the bottom surface 31a and the convex surface 31b may form a substantially triangular shape in a transverse cross-sectional view.

As described above, the convex surface 31b is preferably constituted by one or more curved surfaces and/or one or more flat surfaces, and the core 31 preferably includes a portion whose thickness gradually decreases from a the center side to the widthwise ends in a transverse cross-sectional view. With such a shape, the cross-sectional area of the core 31 can be reduced, allowing light to be more effectively confined to the central portion of the core 31.

From the viewpoint of improving the optical coupling efficiency with the first waveguide 20, the convex surface 31b is preferably constituted by only a curved surface. The arrangement in which the convex surface 31b is formed of only a curved surface can alleviate both the deterioration of the coupling efficiency occurring upon a change of the width W of the core 31 in the transverse direction and the requirement of the alignment accuracy of the core 31 with respect to the first waveguide 20.

When the convex surface 31b is formed of only a curved surface, it is preferable that the core 31 is oblong in a transverse cross-sectional view in which the thickness is smaller than the width and the thickness gradually decreases from the center side to the widthwise ends. In this case, the core 31 in the transverse cross-sectional view may be formed of, for example, a semi-circular shape, a semi-elliptical shape, a semi-oval shape, or the like.

In the transverse direction, as long as the bottom surface 31a has a sufficient width in the Y direction, the maximum width of the convex surface 31b in the Y direction may be greater than the width of the bottom surface 31a in the Y direction.

The width W of the core 31 in the transverse direction may be, for example, about 2 μm to 10 μm. The thickness T of the core 31 may be, for example, about 1 μm to 5 μm. It is preferable to determine the width W and the thickness T in consideration of the transverse cross-sectional area of the core 31.

The cladding 32 is provided on the first surface 10a of the substrate 10 and covers the core 31. The cladding 32 may be formed of, for example, a material whose main component is a silicone resin. The cladding 32 may alternatively be formed of a material whose main component is an acrylic resin, an epoxy resin, a polyimide resin, a polyolefin resin, a polynorbornene resin, or the like. Alternatively, the cladding 32 may be formed of a material obtained by mixing these resins. Alternatively, the cladding 32 may be formed of inorganic glass such as quartz or borosilicate.

The cladding 32 is formed of a material having a lower refractive index than the central portion of the core 31. If the refractive index of the central portion of the core 31 is, for example, about 1.52, the refractive index of the cladding 32 may be set to a lower value, for example, about 1.51. The refractive index of the cladding 32 is preferably equal to the refractive index of the substrate 10. The cross-sectional shape of the cladding 32 may be, for example, rectangular. The thickness of the cladding 32 may be determined as appropriate depending on the width and thickness of the core 31, manufacturing conditions, and the like, but is preferably about a few or several millimeters, more preferably about 50 to 1000 μm.

In this manner, the optical waveguide device 1 is such that in the region R, the core 31 has the bottom surface 31a in contact with the first surface 10a, and the convex surface 31b connected to the bottom surface 31a. The convex surface 31b is formed of one or more curved surfaces and/or one or more flat surfaces.

For example, if the cross-sectional shape of the core is substantially circular as in the related art, the contact area between the core and the first surface 10a becomes extremely small. Since the width of the first waveguide is usually about 1 μm or less, even a slight positional displacement of the circular core along the width direction of the first waveguide causes an increase in the loss and a decrease in the optical coupling efficiency between the core and the first waveguide.

In the case of the optical waveguide device 1, on the other hand, the core 31 has the bottom surface 31a in contact with the first surface 10a, so that the position of the core 31 is allowed to deviate in the width direction of the first waveguide 20 to some extent. With this arrangement, the alignment between the core 31 and the first waveguide 20 becomes easier than in the case of a substantially circular core as illustrated in, for example, Patent Document 1. This enables the realization of the optical waveguide device 1 in which the first waveguide 20 and the second waveguide 30 are coupled with high optical coupling efficiency. In addition, when a plurality of optical waveguide devices 1 are manufactured, variations in optical coupling efficiency among the optical waveguide devices 1 can be reduced. Details in this regard will be described later with simulation results.

### [Method of Making an Optical Waveguide Device]

In the following, a method of making the optical waveguide device 1 will be described, with a focus on a manufacturing process of the second waveguide 30.

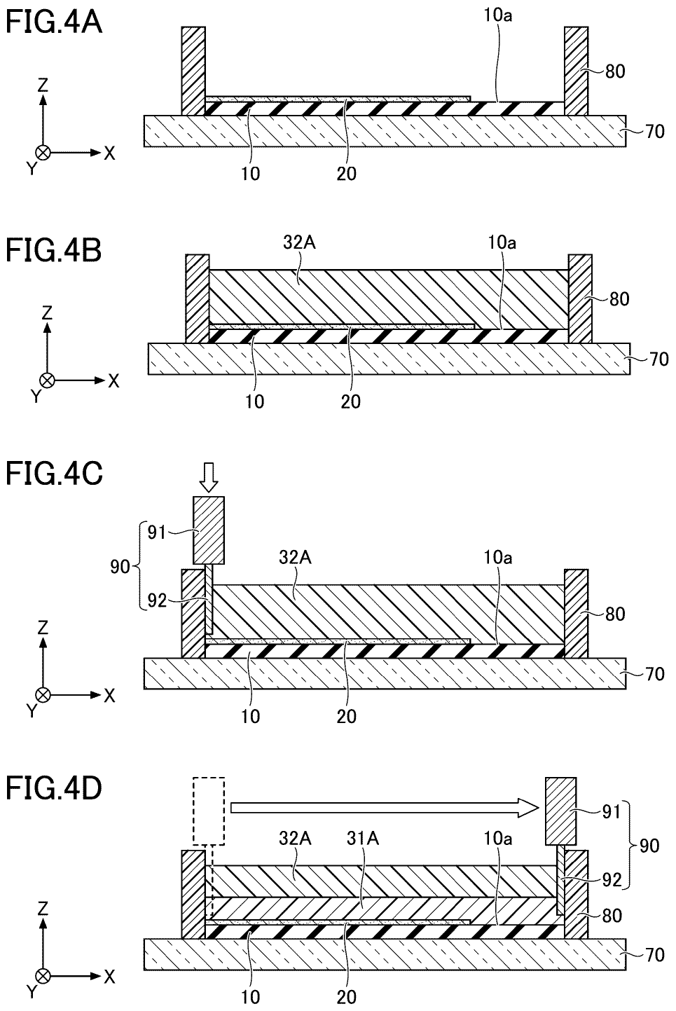

FIGS. 4A through 4D are drawings illustrating an example of the manufacturing process of the optical waveguide device according to the first embodiment. First, in the step illustrated in FIG. 4A, a support 70 is prepared, and a frame 80 is detachably disposed on the upper surface of the support 70. Then, a substrate 10 having the first waveguide 20 formed thereon is disposed on the upper surface of the support 70 exposed inside the frame 80 such that the first waveguide 20 is opposite from the upper surface of the support 70 across the substrate 10.

The support for example, a 70 has, substantially rectangular shape in plan view. The frame 80 has, for example, a rectangular frame shape in plan view. As the materials of the support 70 and the frame 80, for example, resin (e.g., acrylic), glass, silicon, ceramics, metals, and the like may be used. The support 70 and the frame 80 may be formed using the same material or different materials.

Next, in the step illustrated in FIG. 4B, a predetermined material is applied to the first surface 10a of the substrate 10 exposed inside the frame 80, and a cladding 32A having a substantially constant layer thickness is formed uniformly over the surface. The cladding 32A is mainly composed of a resin precursor paste having viscosity (i.e., appropriate fluidity and formability), and is a portion that will be cured through polymerization in a later process to ultimately become the cladding 32. The resin precursor is a precursor compound that can be polymerization-cured to form a resin.

The material of the cladding 32A may be, for example, a material that is mainly composed of a resin precursor that can be polymerization-cured to form a silicone resin. The material of the cladding 32A may be, for example, a material that is mainly composed of a resin precursor that can be polymerization-cured to form an acrylic resin, an epoxy resin, a polyimide resin, a polyolefin resin, a polynorbornene resin, or the like. Alternatively, the material of the cladding 32A may be, for example, a material that is mainly composed of a plurality of resin precursors that can be polymerization-cured to form the above-noted resins. The material of the cladding 32A can be selected as appropriate to provide photo-curable property, thermosetting property, thermoplastic property, and the like. The viscosity of the cladding 32A may be, for example, about 10300 cPs. The cladding 32A may be produced by using, for example, a coating apparatus (i.e., dispenser or the like), a printing apparatus, or the like.

In the step illustrated in FIG. 4C, a coating apparatus (not shown) having a discharge unit 90 (including a discharge body 91 and a needle-shaped portion 92) is prepared, and is then operated so that a part of the needle-shaped portion 92 at the tip of the discharge unit 90 is pierced into the cladding 32A. The distance in the Z direction from the first surface 10a of the substrate 10 to the tip of the needle-shaped portion 92 may be selected as appropriate, but may be, for example, about 1 to 8 μm, and preferably about 2 to 4 μm.

The coating apparatus includes a CPU, a memory, and the like, and has the function to move accurately the discharge unit 90 with respect to the cladding 32A at predetermined moving speeds in the X, Y, and Z directions by programming. The needle-shaped portion 92 has, for example, an annular cross-sectional shape, and the coating apparatus has the function to discharge a predetermined material through the annular structure of the needle-shaped portion 92 at a predetermined discharge pressure. The inner diameter of the annular structure of the needle-shaped portion 92 may be selected as appropriate, and may be, for example, about 35 to 100 μm. The coating apparatus may include, for example, a desktop coating robot, a dispenser, and the like.

In the step illustrated in FIG. 4D, the coating apparatus is operated to form the core 31A by moving the needle-shaped portion 92 within the cladding 32A while discharging the predetermined material from the needle-shaped portion 92 pierced into the cladding 32A. The direction of movement of the needle-shaped portion 92 may be selected as appropriate, but in this example, the needle-shaped portion is moved along the X direction. The moving speed of the needle-shaped portion 92 may be selected as appropriate, and may be, for example, about 5 to 30 mm/s. The discharge pressure of the needle-shaped portion 92 may be selected as appropriate, and may be, for example, about 100 to 400 kPa.

The core 31A is composed mainly of a paste resin precursor having viscosity (i.e., appropriate fluidity and formability) and is polymerization-cured in a later process to ultimately become the core 31. As the material of the core 31A, for example, a material composed mainly of a resin precursor which can be polymerization-cured to form a silicone resin may be used. As the material of the core 31A, for example, a material composed mainly of a resin precursor which can be polymerization-cured to form an acrylic resin, an epoxy resin, a polyimide resin, a polyolefin resin, a polynorbornene resin or the like may be used. Alternatively, as the material of the core 31A, for example, a material composed mainly of a plurality of resin precursors which can be polymerization-cured to form the above-noted resins may be used. The material of the core 31A may be selected as appropriate to provide photo-curable property, thermosetting property, thermoplastic property, or the like. The viscosity of the core 31A may be, for example, about 70,000 cPs.

The moving speed of the discharge unit 90, the discharge pressure of the needle-shaped portion 92, and the inner diameter of the annular structure of the needle-shaped portion 92 are adjusted in accordance with the material of the core 31A and the material of the cladding 32A. Further, the tip of the needle-shaped portion 92 is brought to an appropriate proximity to the first surface 10a of the substrate 10. These arrangements effectively form, for example, the core 31A having a semicircular cross-sectional shape or the like and having a refractive index higher at the center and lower at the periphery.

When there is a long distance in the Z direction between the first surface 10a of the substrate 10 and the tip of the needle-shaped portion 92, the cross-sectional shape of the created core 31 becomes nearly circular. In order to make the cross-sectional shape of the core 31 semicircular including the bottom surface 31a and the convex surface 31b as illustrated in FIG. 1C, it is thus preferable to bring the tip of the needle-shaped portion 92 to an appropriate proximity to the first surface 10a of the substrate 10. When the tip of the needle-shaped portion 92 is at an appropriate distance from the first surface 10a of the substrate 10, the bottom surface 31a is formed by the drag from the first surface 10a of the substrate 10, resulting in the cross-sectional shape of the core 31 becoming semicircular.

After the step illustrated in FIG. 4D, the discharge unit 90 is removed, and the core 31A and the cladding 32A are polymerization-cured by a predetermined method. For example, the core 31A and the cladding 32A, when made of light-curable materials, are cured by irradiation with light (such as ultraviolet light). When the material used is such that it cannot be fully cured solely through light irradiation, heat may be applied after the light irradiation.

As a result, the core 31A and the cladding 32A, which are mainly composed of resin precursor paste, are both polymerization-cured to form the core 31 and the cladding 32, respectively, which are mainly composed of a resin. Further, the core 31 and the cladding 32 are removed from the support 70 and the frame 80, which completes the fabrication of the optical waveguide device 1 illustrated in FIGS. 1A through This method is known as the Mosquito method.

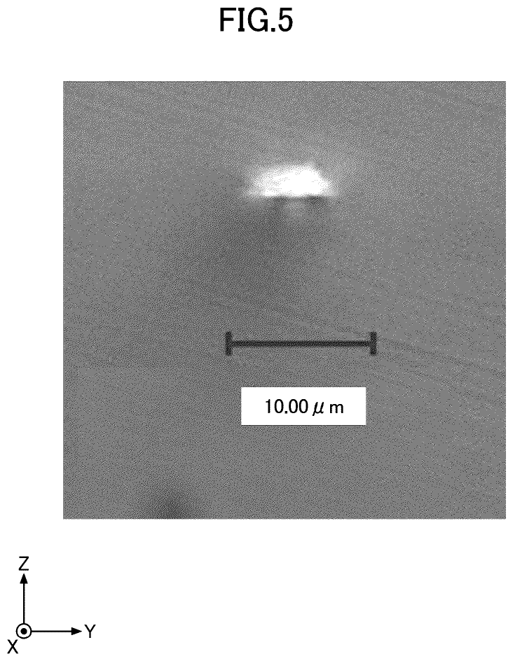

FIG. 5 is a photographic image illustrating an example of a cross-sectional shape of the core, and, more specifically, illustrates a transverse cross-section of the core in the optical waveguide device manufactured by the Mosquito method. In FIG. 5, a portion that appears bright is a cross-section of the core. It can be confirmed from FIG. 5 that a core having a substantially semicircular transverse cross-sectional shape is formed. The width and thickness of the cross-sectional shape of the core are both 10 μm or less.

The method of forming the second waveguide 30 in the optical waveguide device 1 is not limited to the Mosquito method, and other methods may be used as appropriate. The second waveguide 30 may be formed by, for example, a photolithography method, an imprint method, a laser drawing method, a photo addressing method, or the like.

### <Simulation>

With respect to an optical waveguide device having the structure illustrated in FIGS. 1A through 1C, the optical coupling efficiency between the core and the first waveguide optically coupled to each other was derived by optical simulation (FIMMWAVE and FIMMPROP). FIMMWAVE and FIMMPROP are software for analyzing propagation modes of waveguides.

### <<First Simulation>>

In the first simulation, the first waveguide was a silicon waveguide. The thickness of the silicon waveguide was fixed to 0.22 μm, the width of the non-tapered portion was fixed to 0.08 μm, and the length TL of the tapered portion was varied between 50 μm and 1000 μm. The second waveguide was a polymer waveguide. With respect to the second waveguide, the shape of the core was semicircular, the thickness T of the core was fixed at 1.5 μm, and the width W was varied between 2 μm and 6 μm. The core was assumed to be an organic-inorganic hybrid resin provided by Nissan Chemical. The cladding was assumed to have a refractive index that is the same as or close to that of the substrate.

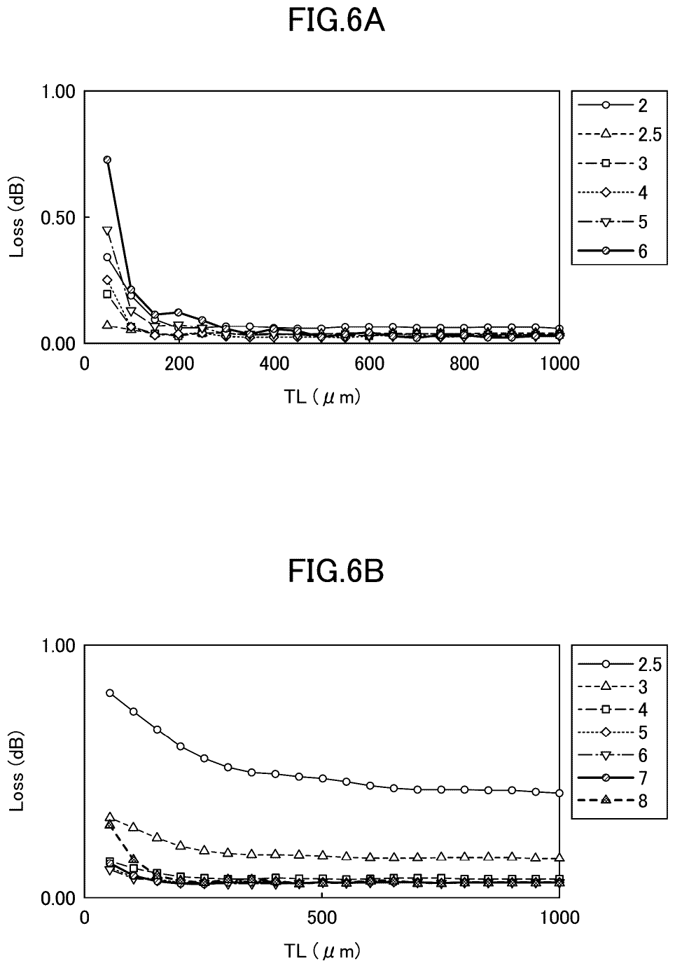

The results are illustrated in FIG. 6A. In FIG. 6A, the horizontal axis represents length TL and the vertical axis represents loss. As illustrated in FIG. 6A, it was found that, with the cross-sectional shape of the core being semicircular, the loss was 1 dB or less regardless of the length TL or the width W of the core, and the core and the first waveguide were optically coupled with high optical coupling efficiency. In particular, it was found that when the length TL was 150 μm or more, the loss was 0.2 dB or less, and the core and the first waveguide were optically coupled with extremely high optical coupling efficiency.

### <<Second Simulation>>

The second simulation was substantially the same as the first simulation, except that the core thickness T was fixed at 1.0 μm, and the width W was varied between 2.5 μm and 8 μm.

The results are illustrated in FIG. 6B. In FIG. 6B, as in FIG. 6A, the horizontal axis represents length TL and the vertical axis represents loss. As illustrated in FIG. 6B, even when the core thickness T was set to 1.0 μm, the loss was less than 1 dB in all results, indicating that the core and the first waveguide were optically coupled with high optical coupling efficiency.

However, when the core width was 2.5 μm, the loss increased by a factor of about 5 as compared with when the core width was 4 μm or more, regardless of the length TL. When the core width was 3 μm, the loss increased by a factor of about 2 as compared with when the core width was 4 μm or more, regardless of the length TL. In contrast, when the core width was 4 μm or more, the loss was comparable to when the core thickness was 1.5 μm in the first simulation.

It is considered important at what slope the thickness of the convex surface 31b decreases from the center to the widthwise ends. Also, the cross-sectional area of the core 31 is important. When the area is too small, the loss tends to be high, and also when the area becomes large, the loss tends to increase. In other words, while ensuring that the core 31 has an appropriate cross-sectional area, it is important to increase the width of the convex surface 31b. It is possible to determine an appropriate cross-sectional area of the core 31 by considering the effect of confining light into the center portion of the core 31 and whether the seeping light from the core 31 overlaps the first waveguide 20.

### <<Third Simulation>>

In the third simulation, loss was compared between the semicircular core (of the embodiment) and a circular core (as a comparative example) for various core diameters and lengths TL. The diameter of the semicircular core is the width of the bottom surface of the core in contact with the first surface of the substrate in a transverse cross-sectional view. Other conditions were the same as those in the first simulation.

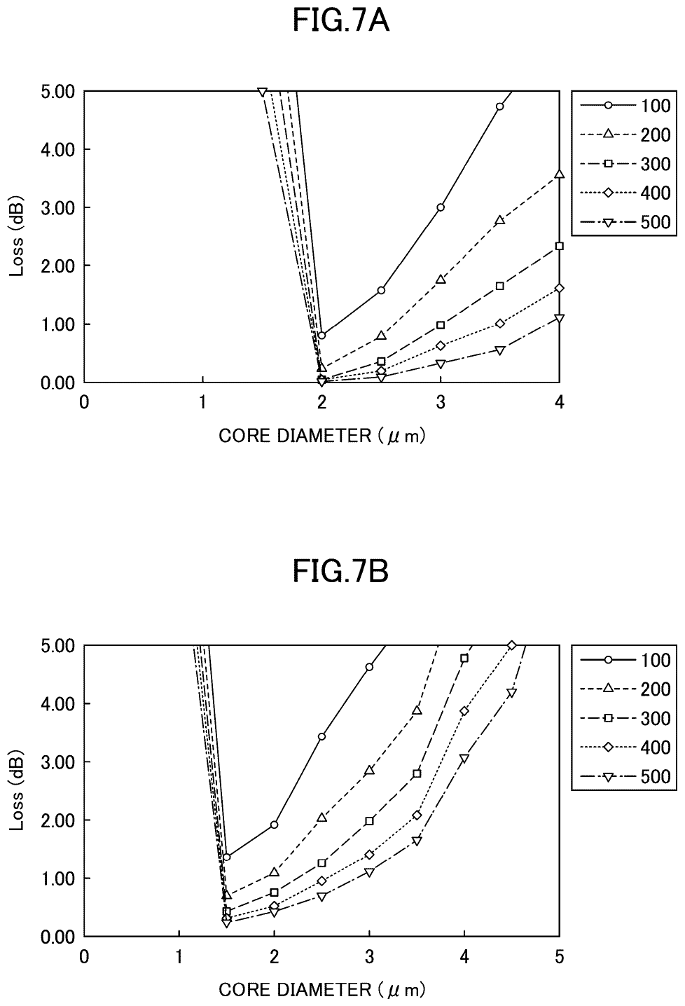

The results for the semicircular core are illustrated in FIG. 7A. The results for the circular core are illustrated in FIG. 7B. In FIG. 7A and FIG. 7B, the horizontal axis is the diameter of the core, and the vertical axis is the loss. From FIG. 7A and FIG. 7B, it was found that when the diameter was 2 μm or more, the loss of the semicircular core is lower than that of the circular core regardless of the length TL.

### <<Fourth Simulation>>

In the fourth simulation, loss was compared between the semicircular or semi-elliptical core (of the embodiment) and a rectangular or square core (as a comparative example) for various thicknesses and widths. Other conditions were the same as those in the first embodiment.

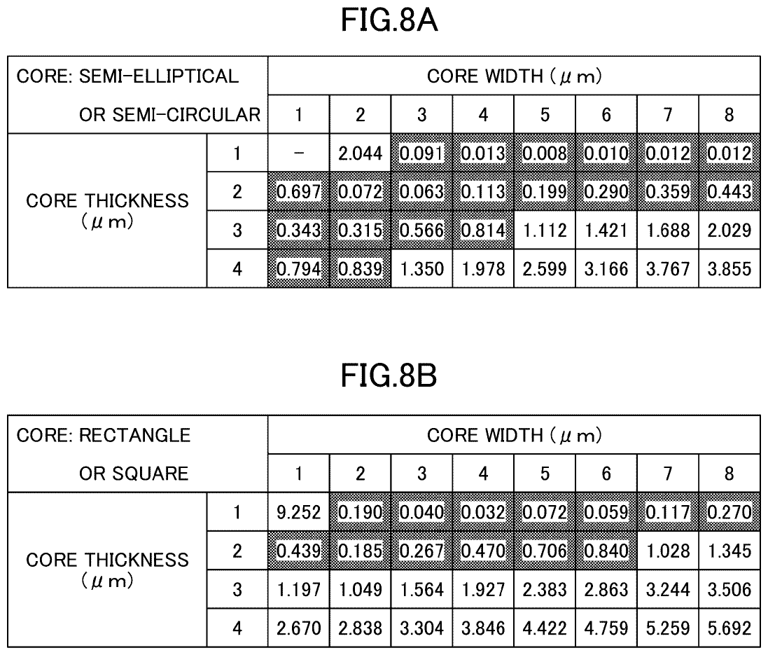

The results for the semicircular or semi-elliptical core are illustrated in FIG. 8A. FIG. 8B illustrates the results for the rectangular or square core. In FIGS. 8A and 8B, the unit of loss is dB, and the shaded area indicates the area where the loss is 1 dB or less.

It was found, as illustrated in FIGS. 8A and 8B, that when the shape of the core was semi-elliptical or semi-circular, the shaded area greatly increased compared to when the shape of the core was rectangular or square. The wider the shaded area, the more choices of the thickness and width of the core, and the greater the tolerance of the dimensional accuracy at the time of manufacturing. That is, the semi-elliptical or semi-circular core offers more choices of the thickness and width of the core than the rectangular or square core, and also provides a greater tolerance of the dimensional accuracy at the time of manufacturing.

From the results of the first through fourth simulations, it can be seen that when the core having a semi-circular cross-sectional shape as illustrated in FIG. 1C is used, the tolerance of the width of the core can be increased from the viewpoint of optical coupling efficiency. That is, since the core having a properly wide width can be formed, the alignment accuracy requirements at the time of forming the core and the manufacturing accuracy requirements for the shape of the core can be relaxed in the manufacturing process of the optical waveguide device.

### Variations of First Embodiment

In the first variation of the first embodiment, description of the same components as those of the already described embodiment may sometimes be omitted.

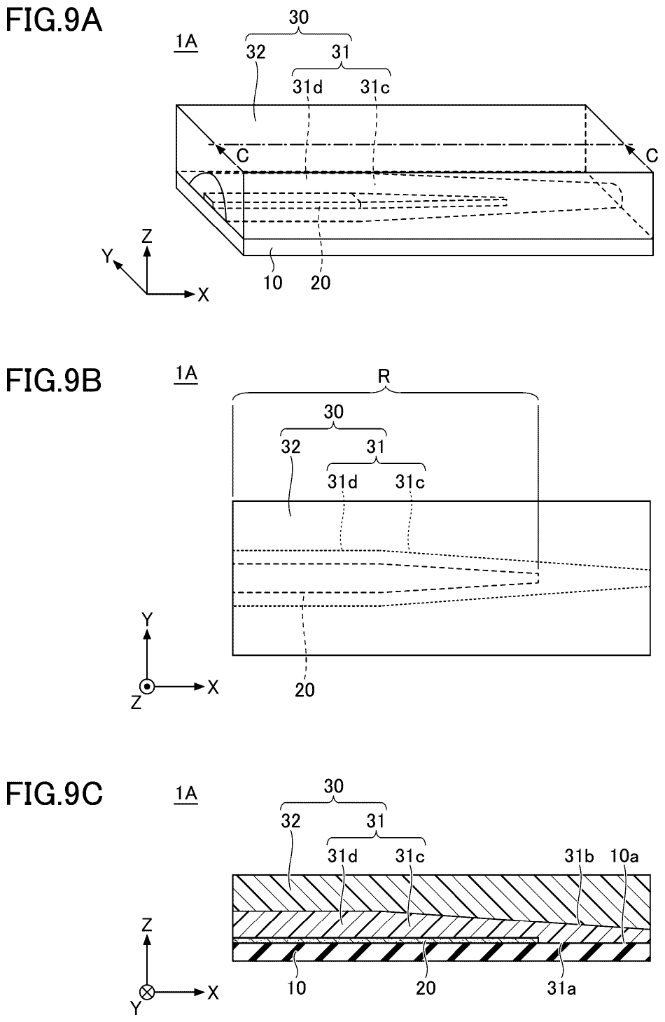

FIGS. 9A through 9C are drawings illustrating an example of an optical waveguide device according to the first variation of the first embodiment. FIG. 9A is an axonometric view, and FIG. 9B is a plan view. FIG. 9C is a cross-sectional view taken along the line C-C in FIG. 9A. FIG. 9C is a cross-sectional view of an optical waveguide device 1A cut in a plane parallel to the XZ plane passing through the longitudinal center of the core 31.

The optical waveguide device 1A illustrated in FIGS. 9A through 9C differs from the optical waveguide device 1 in that the core 31 includes a tapered portion 31c and a non-tapered portion 31d.

As illustrated in FIG. 9B, the core 31 may include, in the region R, a tapered portion 31c whose width gradually decreases toward one side in the longitudinal direction (toward the positive X direction) in plan view. The non-tapered portion 31d continues from the tapered portion 31c toward the negative X direction. In the region R, the core 31 may include a tapered portion whose width gradually increases toward one side in the longitudinal direction (toward the positive X direction) in plan view.

In plan view, the core 31 may include a tapered portion 31c in other regions than the region R. In plan view, the core 31 in other regions than the region R and in the region R may be entirely a tapered portion 31c. That is, the core 31 may not include the non-tapered portion 31d.

As illustrated in FIG. 9C, the thickness of the tapered portion 31c may gradually decrease toward one side in the longitudinal direction (toward the positive X direction). Alternatively, the thickness of the tapered portion 31c may gradually increase toward one side in the longitudinal direction (toward the positive X direction).

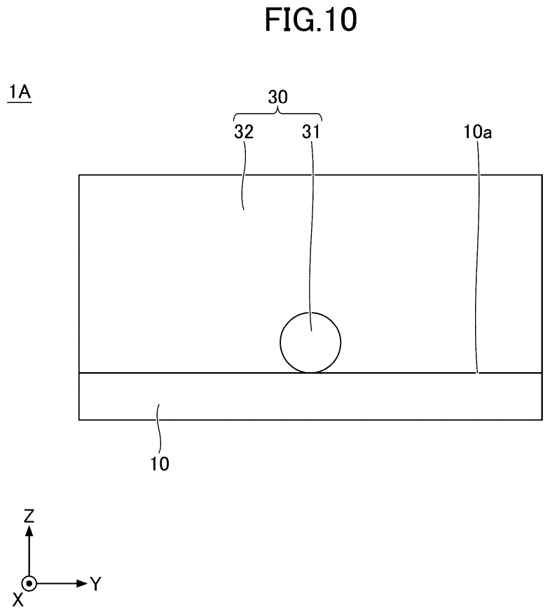

FIG. 10 is a view illustrating one end of the optical waveguide device 1A viewed from the positive X side toward the negative X side. As illustrated in FIG. 10, outside the region R, the core 31 may include a circular portion in a transverse cross-sectional view. In the example illustrated in FIG. 10, one longitudinal end of the core 31 is circular. With such a shape, the longitudinal end of the core 31 can be easily optically coupled with the optical fiber. In the present application, the term “circular” means approximately circular, and does not mean exactly a perfect circle. Therefore, the core may be deviated from a perfect circle within a range that does not substantially impair a predetermined effect as an optical waveguide.

In order to make the cross-sectional shape of the core 31 circular, in the Mosquito method, for example, the distance in the Z-direction from the first surface 10a of the substrate 10 to the tip end of the needle-shaped portion 92 may be made longer than in the case where the core 31 is semicircular.

It may be noted that even if the core 31 is composed only of the non-tapered portion 31d, the core 31 may include a circular portion in a transverse cross-sectional view as long as such a portion is situated outside the region R.

Further, even when the first waveguide 20 does not have a tapered portion, the core 31 of the second waveguide 30 may have a tapered portion 31c. The tapered portion 31c may be disposed only outside the region R. Further, the core 31 may include a tapered portion whose width and thickness gradually increase toward one side in the longitudinal direction (toward the positive X direction).

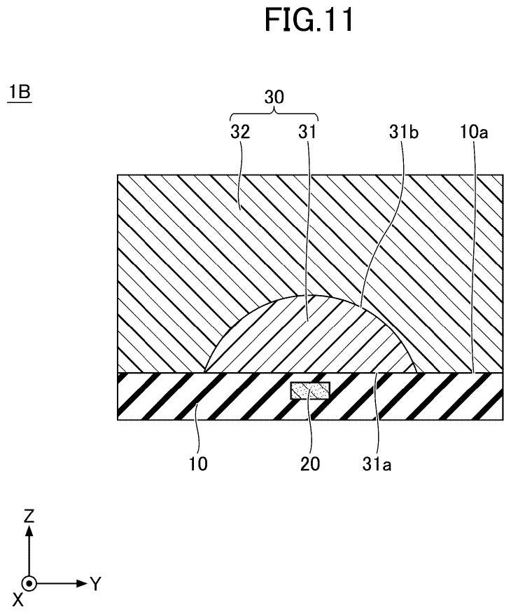

FIG. 11 is a cross-sectional view illustrating an example of an optical waveguide device according to the second variation of the first embodiment, and illustrates a cross-sectional view corresponding to FIG. 1C.

The optical waveguide device 1B illustrated in FIG. 11 differs from the optical waveguide device 1 in that the first waveguide 20 is embedded in the substrate 10. That is, the upper surface, the lower surface, and the side surfaces of the first waveguide 20 are covered with the substrate 10. The upper surface of the first waveguide 20 may alternatively be exposed in the same plane as the first surface 10a of the substrate 10 while the lower surface and the side surfaces may be covered with the substrate 10. As described above, the first waveguide 20

may not protrude above the first surface 10a of the substrate 10. In this with case as well, the configuration in which the core 31 has the bottom surface 31a in contact with the first surface 10a and the convex surface 31b connected to the bottom surface coupling efficiency 31a, high optical can be maintained between the core 31 and the first waveguide 20 even when the position of the core 31 is shifted in the width direction of the first waveguide 20. This allows for an increase in the yield of products, and enables the realization of the optical waveguide device 1B that is stable with only small variations in optical coupling efficiency among products.

With the configuration in which the first waveguide 20 is embedded in the substrate 10, the optical coupling efficiency between the first waveguide 20 and the core 31 is effectively improved when the cross-sectional shape of the core 31 is flatter than when the first waveguide 20 is not embedded in the substrate 10. That is, by making the cross-sectional shape of the core 31 flatter, the confinement of light in the thickness direction of the core 31 is weakened, and the light in the propagation mode within the core 31 seeps deeper into the substrate 10 (evanescent light). The greater the overlap between the evanescent light and the first waveguide 20, the more improved the optical coupling efficiency is due to an increased likelihood of light transition resulting from the mode coupling between the core 31 and the first waveguide 20.

According to at least one embodiment, it is possible to provide an optical waveguide device in which two waveguides are coupled with high optical coupling efficiency.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An optical waveguide device comprising:
a substrate;
a first waveguide disposed on or in the substrate; and
a second waveguide disposed on a first surface of the substrate,
wherein the second waveguide includes a core and a cladding covering the core,
entirety wherein throughout an of a predetermined region, a portion of the core overlaps the first waveguide when viewed from a direction normal to the first surface,
wherein in the predetermined region, the core has a bottom surface in contact with the first surface and a convex surface connected to the bottom surface, and
wherein the core includes a portion whose thickness gradually decreases from a widthwise center to widthwise ends in a transverse cross-sectional view.

2. The optical waveguide device as claimed in claim 1, wherein
in a transverse cross-section, the core has a laterally oblong shape with a height thereof less than a width thereof.

3. The optical waveguide device as claimed in claim 1, wherein the convex surface is a curved surface.

4. The optical waveguide device as claimed in claim 1, wherein in the predetermined region, when viewed from the direction normal to the first surface, the first waveguide includes a portion whose width gradually decreases toward one side in a longitudinal direction thereof.

5. The optical waveguide device as claimed in claim 1, wherein, when viewed from the direction normal to the first surface, the core includes a longitudinal portion whose width gradually decreases or gradually increases toward one side in a longitudinal direction thereof.

6. The optical waveguide device as claimed in claim 5, wherein a thickness of the longitudinal portion gradually decreases or gradually increases toward the one side in the longitudinal direction.

7. The optical waveguide device as claimed in claim 1, wherein outside the predetermined region, the core includes a circular portion in a transverse cross-sectional view.

8. The optical waveguide device as claimed in claim 1, wherein the first waveguide is embedded in the substrate.

9. The optical waveguide device as claimed in claim 1, wherein the first waveguide contains silicon, silicon nitride, gallium arsenide, or lithium niobate.

10. The optical waveguide device as claimed in claim 1, wherein the second waveguide is a polymer waveguide.
